(19) United States
(12) Patent Application Publication
(10) Pub. No.: US 2008/0134776 A1
(43) Pub. Date: Jun. 12, 2008

(54) PRESSURE AND LIQUID LEVEL SENSING SYSTEM FOR TANK CONTAINERS AND TANK VEHICLES

(75) Inventors: Shouqin Zhou, Shenzhen (CN); Zhangui Duan, Shenzhen (CN); Tao Peng, Shenzhen (CN); Pingan Jiang, Shenzhen (CN); Jie Gao, Shenzhen (CN)

Correspondence Address: PEARNE & GORDON LLP, 1801 EAST 9TH STREET, SUITE 1200, CLEVELAND, OH, 44114-3108, US

(73) Assignee: China International Marine Containers (Group) Ltd., Shenzhen (CN)

(21) Appl. No.: 11/868,710

(22) Filed: Oct. 8, 2007

(30) Foreign Application Priority Data
Oct. 10, 2006 (CN) 200620015182.0

(51) Int. Cl. G01F 23/14

(52) U.S. Cl. 73/291

(57) ABSTRACT

A pressure and liquid level sensing system for a tank container or tank vehicle comprising a vessel for containing a liquid substance, such as Liquified Natural Gas (LNG), etc. The pressure and liquid level sensing system comprises a pressure sensor for measuring a gas pressure inside the vessel and a liquid level sensor for measuring a liquid level inside the vessel, the pressure sensor and the liquid level sensor comprises a first and a second pressure sensitive elements and a first and a second printed circuit boards respectively. A circuit on the first printed circuit board converts a pressure signal into an electric signal, a circuit on the second printed circuit board converts pressure signals of a gas-phase space and a liquid-phase space into electric signals of 4-20 mA or 0-10V standard. In this way, the pressure and the liquid level can be accurately measured. Furthermore, the measured values are digitalized, such that both driver and remote control center can know variation conditions of the pressure and the liquid level of the transported medium in real time, thereby transportation safety is improved.

### FIELD OF THE INVENTION

The present application relates to a tank vessel, particularly, an equipment for measuring a fluid pressure and a liquid level inside a tank vessel.

### BACKGROUND OF THE INVENTION

Most conventional tank containers and tank vehicles are equipped with pressure sensors and liquid level sensors for transmitting analog quantity values of pressures and liquid levels of tankers to analog dashboards. To learn a pressure and a liquid level of a certain tank container or tank vehicle, one has to observe the dashboard by naked eye. Moreover, for sake of safety, a driver has to closely observe the value of the pressure inside tank vehicle during transportation, in order to ensure the tank is not in danger of an explosion or the like due to increased pressure. Such a mode has defects as follows, first, the signals picked up are not sufficiently accurate; second, observation is not convenient: because the dashboard is attached to the tank, the driver has to turn his head for observing the pressure value during transportation, which further increases danger of transportation. Moreover, the dashboard of the liquid level meter is generally mounted inside a control box, it is not easy for the driver to learn variation of the liquid level while driving, if there is a medium leakage during transportation, however, the driver cannot find out it in time, then on the one hand, the cargo may lose, and on the other hand, a safety accident may take place because the transported medium itself has characteristics of flammability and toxicity, etc.

### SUMMARY OF THE INVENTION

The invention is aimed to overcome the defects of the prior art, realizing digitalization of values of pressures and liquid levels of the tank containers and tank vehicles, allowing both of drivers and remote controlling terminals, during transportation of the tank containers and tank vehicles, timely knowing variation conditions of the transportation medium, such as pressures and liquid levels, so as to improve safety of transportation.

For achieving the above purposes, the invention provides a pressure and liquid level sensing system for a tank container or tank vehicle, the tank container or tank vehicle comprises a vessel for containing a liquid substance. The pressure and liquid level sensing system for a tank container or tank vehicle comprises a pressure sensor for measuring a gas pressure inside the vessel and a liquid level sensor for measuring a liquid level inside the vessel. The pressure sensor comprises a first pressure sensitive element having a pressure input port which is connected to a gas-phase space of the vessel via a tube. The liquid level sensor comprises a second pressure sensitive element having a first and a second pressure input ports, wherein the first pressure input port is connected to a gas-phase space of the vessel via a tube; and the second pressure input port is connected to a liquid-phase space of the vessel via a tube. The pressure sensor comprises a first circuit board which in turn comprise a first processing circuit for converting a pressure at the pressure input port into an electric signal of voltage or current; the liquid level sensor comprises a second circuit board which in turn comprises a second processing circuit for converting pressure signals at the first and second pressure input ports into an electric signal of voltage or current.

The first circuit board further comprises a first signal adjusting circuit which converts the electric signal provided by the first processing circuit into an electric signal of 4-20 mA or 0-10V standard. The electric signal provided by the first signal adjusting circuit is an output signal of the pressure sensor.

The second circuit board further comprises a calculating circuit which calculates a liquid level value based on the electric signal provided by the second processing circuit, and a second signal adjusting circuit which converts the electric signal provided by the calculating circuit into an electric signal of 4-20 mA or 0-10V standard. The electric signal provided by the second adjusting circuit is an output signal of the liquid level sensor.

The calculating circuit comprises a microprocessor.

The pressure input port of the first pressure sensitive element comprises a pressure interface which has a thread connection with a body of the pressure sensor. In the second pressure sensitive element, the first pressure input port comprises a first pressure interface, and the second pressure input port comprises a second pressure interface. The first and second pressure interfaces are located at a same interface component which has a thread connection with a body of the liquid level sensor. Compared with the prior art, the pressure and liquid level sensing system of the invention for tank containers and tank vehicles are accurate for measurement, and the measured value can be digitalized, allowing drivers and remote controlling terminals knowing variation conditions of the transported medium, such as pressures and liquid levels, etc, thereby improving transportation safety.

### BRIEF DESCRIPTION OF DRAWINGS

FIG. 1 is a schematic drawing showing a practical connection for the pressure sensor and the liquid level sensor in an embodiment of the pressure and liquid level sensing system of the invention for tank containers and tank vehicles;

FIG. 2 is a schematic drawing showing the structure of the pressure sensor in an embodiment of the invention;

FIG. 3 is a schematic drawing showing the structure of the liquid level sensor in an embodiment of the invention;

FIG. 4 is a schematic drawing showing electrical principle of the circuit board in an embodiment of the invention.

### DETAILED DESCRIPTION OF THE PREFERRED EMBODIMENTS

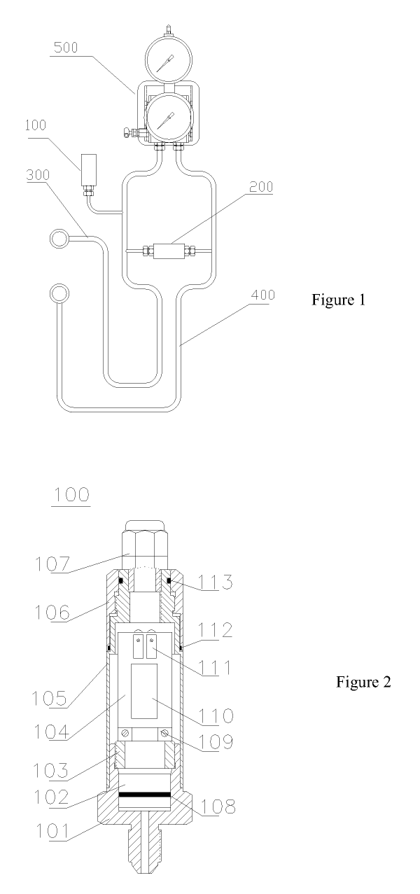

The invention will be described more detailed hereinbelow by referring to the drawings. According to an embodiment of the pressure and liquid level sensing system of the invention for tank containers and tank vehicles, as shown in FIG. 1, a pressure sensor 100 may measure a gas pressure inside a tank via a gas-phase tube 300 which is connected to interior of the tank, a liquid level sensor 200 may measure a liquid level inside the tank via the gas-phase tube 300 and a liquid-phase tube 400 which is also connected to interior of the tank. Signals of the pressure sensor 100 and the liquid level sensor 200 may be transmitted to a digital display apparatus which is mounted at a proper position such as a driving cab, so as to accurately show conditions of a pressure and a liquid level of the vessel in real time. Or information of the pressure and the liquid level may be transmitted wirelessly to a remote controlling terminal, allowing the remote controlling terminal remotely tracking conditions of the pressure and the liquid level of a given vessel.

The components of the pressure sensor 100, as shown in FIG. 2, comprise: a first pressure sensitive element 102 having a pressure connector 101 of YZG4 standard as its pressure input port, a compression ring 103; a first printed circuit board 104 comprising a circuit 110 which comprises a first processing circuit and a first signal adjusting circuit; a casing 105, an upper cover 106, an outgoing line locking apparatus 107, an O-ring 108 which is tolerant to low temperature; a screw 109; a potentiometer 111; and O-rings 112, 113. Wherein the first sensitive element 102 is connected to the first printed circuit board 104, such that a pressure signal of the first pressure element 102 may be converted into an electric signal by the first processing circuit of the circuit 110 on the first printed board 104, and the electric signal is then adjusted to a signal of 4-20 mA or 0-10V standard by the first signal adjusting circuit of the circuit 110. The standardized signal is subsequently transmitted from the pressure sensor 100 via a conducting wire. And the pressure connector 101 of YZG4 standard may have a thread connection or flange connection with a body of the pressure sensor 100.

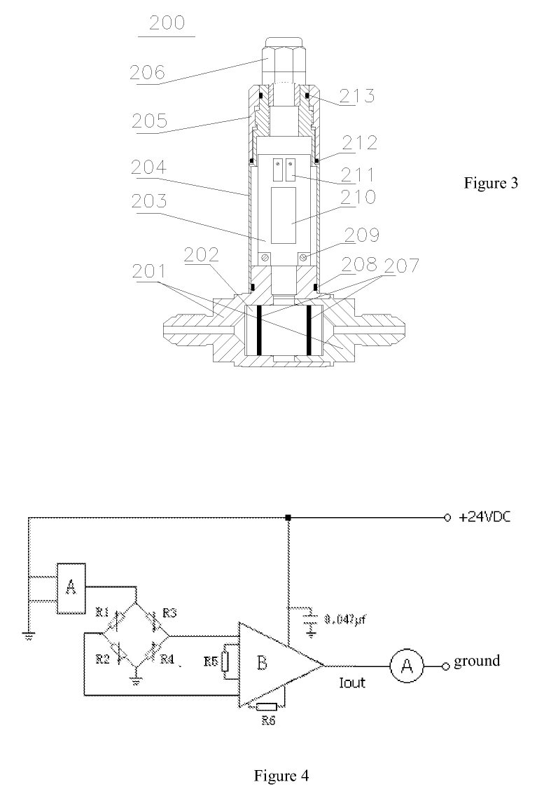

The components of the liquid level sensor 200, as shown in FIG. 3, comprise: a second pressure sensitive element 202 having two pressure connectors 201 of YZG4 standard as a first and a second pressure input ports, wherein the first pressure input port is connected to a gas-phase tube and the second pressure input port is connected to a liquid-phase tube, hence the second pressure sensitive element 202 can provide a gas-phase pressure signal at the first pressure input port and a liquid-phase pressure signal at the second pressure input port; a second printed circuit board 203 comprising a circuit 210 which comprises a second processing circuit, a second signal adjusting circuit, and a calculating circuit; a casing 204; an upper cover 205; an outgoing line locking apparatus 206; two O-rings 207, 208 which are tolerant to low temperature; a screw 209; a potentiometer 211; and O-rings 212, 213. The second pressure sensitive element 202 is connected to the second printed circuit board 203, such that pressure signals at the first and second pressure input ports may be converted into an electric signal by the second processing circuit of the circuit 210 on the second printed circuit board 203, further, a liquid level value is calculated therefrom by the calculating circuit of the circuit 210, and then adjusted to a signal of 4-20 mA or 0-10V standard by the second signal adjusting circuit of the circuit 210. The standardized signal is subsequently transmitted from liquid level sensor 200 via a conducting wire. Additionally, the pressure connector 201 of YZG4 standard may have a thread connection or flange connection with a body of the pressure sensor 200.

For the application to a tank containing LNG, since LNG is a flammable and explosive hazardous material, the mechanical structures of the sensors 100, 200 are required to be explosion suppressible and tightly sealed accordingly. In this embodiment, tightness is secured mainly by utilizing the O-rings, as well as the outgoing line locking apparatus at a protection level of IP68 and the upper cover of a cap structure. The casing may be made of a material of stainless steel. In periodically verifying the sensors, zero and full scale calibrations of the sensors can be carried out by opening the upper cover, and adjusting the two potentiometers on the printed circuit board.

As for the circuits on the first printed circuit board 104 in the sensor 100 and the second printed circuit board 203 in the sensor 200, as shown in FIG. 4, A is a constant current excitation source supplying an exciting current of 1 mA to the sensitive element of the sensor, and B is an operational amplifier of a precision meter carrying out operations of amplifying, converting, and signal adjusting to the signal outputted by the sensitive elements and outputting a signal of 4-20 mA or 0-10V standard. Wherein, a bridge of detection resistors may be packaged in the pressure sensitive elements 102 and 103, optionally, the constant current excitation source A and the operational amplifier B may also be packaged together with the bridge of detection resistors. As for the liquid level sensor 200, since it is needed to calculate the liquid level based on a pressure difference, a microprocessor is further disposed on the second printed circuit board 203 accordingly.

The above content is only some preferred embodiments of the present invention, not the solutions to limit the present invention. Those skilled in the art may easily carry out variations and modifications according to the basic contemplation and spirit of the invention, so the protecting scope of the invention should be defined by the appended claims.

1. A pressure and liquid level sensing system for a tank container or tank vehicle comprising a vessel for containing a liquid substance, comprising a pressure sensor for measuring a gas pressure inside the vessel and a liquid level sensor for measuring a liquid level inside the vessel,
wherein the pressure sensor comprises a first pressure sensitive element having a pressure input port connected to a gas-phase space of the vessel via a tube;
the liquid level sensor comprises a second pressure sensitive element having a first pressure input port connected to a gas-phase space at the top of the vessel via a tube, and a second pressure input port connected to a liquid-phase space at the bottom of the vessel via a tube;
the pressure sensor further comprises a first circuit board having a first processing circuit located thereon for converting a pressure signal at the pressure input port of the first pressure sensitive element into an electric signal of a voltage or current;
the liquid level sensor further comprises a second circuit board having a second processing circuit located thereon for converting a gas-phase space pressure signal at the first pressure input port of the second pressure sensitive element and a liquid-phase space pressure signal at the second pressure input port of the second pressure sensitive element into an electric signal of a voltage or current.

2. The pressure and liquid level sensing system for a tank container or tank vehicle according to claim 1, wherein
the first circuit board further comprises a first signal adjusting circuit which converts the electric signal provided by the first processing circuit into an electric signal of 4-20 mA or 0-10V standard, as an output signal of the pressure sensor.

3. The pressure and liquid level sensing system for a tank container or tank vehicle according to claim 1, wherein
the second circuit board further comprises a calculating circuit for calculating a value of the liquid level based on the electric signal provided by the second processing circuit, and a second signal adjusting circuit for converting an electric signal provided by the calculating circuit into an electric signal of 4-20 mA or 0-10V standard, as an output signal of the liquid level sensor.

4. The pressure and liquid level sensing system for a tank container or tank vehicle according to claim 3, wherein
the calculating circuit comprises a microprocessor.

5. The pressure and liquid level sensing system for a tank container or tank vehicle according to claim 1, wherein
the pressure input port of the first pressure sensitive element comprises a pressure interface which has a thread connection or flange connection with a body of the pressure sensor.

6. The pressure and liquid level sensing system for a tank container or tank vehicle according to claim 1, wherein
the first pressure input port of the second pressure sensitive element comprises a first pressure interface, and the second pressure input port comprises a second pressure interface which is located on the same interface component with the first pressure interface, and the interface component has a thread connection or flange connection with a body of the liquid level sensor.
